(19) United States
(12) Patent Application Publication
(10) Pub. No.: US 2025/0273944 A1
(43) Pub. Date: Aug. 28, 2025

(54) Adjustable Electrical Component Cover

(71) Applicant: Kaddas Enterprises Inc., Salt Lake City, UT (US)

(72) Inventor: James Kaddas, Salt Lake City, UT (US)

(73) Assignee: Kaddas Enterprises Inc., Salt Lake City, UT (US)

(21) Appl. No.: 19/064,322

(22) Filed: Feb. 26, 2025

Related U.S. Application Data
(60) Provisional application No. 63/558,640, filed on Feb. 27, 2024.

(51) Int. Cl. H02G 7/05

(52) U.S. Cl. CPC H02G 7/053

(57) ABSTRACT

An adjustable electrical component cover may have a first cover member and a second cover member which overlap at respective central portion parts to form a rotatable central portion and sidewalls extending therefrom to receive power line segment and an insulator.

### BACKGROUND

### State of the Art

The present invention relates to a protective cover for use with electrical components in order to protect wildlife and electrical systems. In particular, the present invention relates to a protective cover to prevent large birds, racoons, and other wildlife from contacting conductors in a manner to ground the conductor and electrocute the animal. More particularly, the present invention relates to a protective cover which is both fire resistant and can accommodate power line layouts of varying geometries.

### Field of Art

In the conveyance of electricity over power lines it is necessary to periodically support the power line and to connect lines for distribution to various locations. Each of these functions typically occurs on a power pole. The power pole is typically made of metal or wood and may include a cross member to which one or more insulator bushings are attached. A power line is attached to the insulator bushing in such a manner that the insulator bushing electrically isolates the power line from the pole. A connector may be used to bypass the insulator to continue the flow of electricity on the line.

While insulator bushings are effective at preventing the transfer of power from the power line to the power pole, the presence of the power line creates a potential hazard for various forms of wildlife. Birds such as owls, eagles, and other predators often like to perch on the cross member or the top of a power pole because it provides good visibility of potential prey on the ground or even in the air. In many environments, the power pole is the tallest structure around and thus provides the bird with a commanding view of the surrounding environment as they search for prey. Unlike most trees, the power pole provides minimal interruption to lines of sight.

While the power pole is convenient for prey spotting, it can also be deadly for the bird. If a bird stretches its wings while attempting to take flight or to simply maintain its balance, the wings can contact two different lines or some grounding wire, etc. When this occurs, the bird may complete an electrical circuit and may be electrocuted immediately. Thus, it is advantageous to avoid contact between a bird and power line while the bird is disposed on the cross member.

While large birds are a major concern, they are not the only cause of damage to electricity systems. Squirrels, raccoons, and other climbing animals can also climb power poles and other electrical support structures and inadvertently come into contact with conductors, thereby killing the animal and potentially damaging the electrical system and/or causing blackouts. Likewise, while discussed above in the context of utility poles, it will be appreciated that there are a variety of situations in which power lines present a hazard to wildlife, and vice versa, such as at power substations and other locations in which an animal contacting a power line can short circuit the system or serve as a path to ground for the electricity.

While a utility company faces economic loss due to damage to the electrical system caused by the bird or other animal, it may also be subject to liability under various environmental protection laws and/or species preservation laws. Many large raptors and other predatory birds are covered by the Endangered Species Act. If such a bird is killed, a utility company may be subject to civil fines and potentially, criminal penalties if the utility company has not taken adequate steps to prevent harm to wildlife. These fines can be as large as $10,000 for a first offense and quickly escalate if it is apparent that the utility company is not taking reasonable precautions to prevent harm to protected wildlife. Thus, it is advantageous to provide improved protection against accidental electrocution of animals.

Furthermore, the electrocuted animal may catch fire and pose a wildfire concern. If the animal falls in vegetation which is prone to catch fire, a wildfire may quickly develop, causing considerable damage and potential loss of life. In early 2019, PG&E, California's largest utility, filed for bankruptcy. The company faced liability claims for 17 major wildfires in 2017 and was under investigation in several 2018 wildfires, including the Camp Fire in which at least 86 people were killed.

To minimize wildlife being electrocuted, it has become common to place a cover over lines which pose a risk. Some lines are disposed at known angles and can therefore be covered with a generally rigid part. Thus, for example, if two lines are disposed in line or 180 degrees from one another, a rigid piece of material may be used to cover the area which poses the risk. In many situations, however, the area involves power line layouts with other geometries. For example, one line may leave a power pole at a 145-degree angle relative to the adjacent line which creates the area of concern. On the next pole a line may leave at an angle of 125 degrees from the other line which creates an area of concern.

To accommodate for the wide variety of geometries involved, many utilities use line covers which are made from silicone or polyethylene flexible materials. While such covers are advantageous in that they are easy to use. Silicone materials have a tendency to pick up moisture and can catch fire under some conditions. For example, some polyethylenes can catch on fire in certain environmental conditions. As the material melts, burning drops of polyethylene can fall to the ground, potentially sparking a wildfire.

KADDAS Enterprises of Salt Lake City, Utah is known for producing power line protection products made from fire- and flame-resistant materials which will not support combustion, and which are self-extinguishing. The PVC/acrylic blend used by KADDAS is 72 KV rated and thus is highly desirable for covering concern areas along electrical lines. Kaddas' material, however, is fairly rigid, thus providing concerns when the area of concern involves lines which are not disposed along substantially the same axis. While such materials can be heat formed to change their shape, powerlines are often installed in rigged and/or remote terrain where heat forming the covers would be inconvenient.

In U.S. Pat. No. 11,087,901, there is shown an electrical component cover construction which can be made from a PVC/acrylic blend. The electrical component cover has a first end portion and a second end portion with a central portion disposed between the first and second end portions. Between one or both to the end portions, the cover is formed with a flexible portion formed by a bellows-like undulating sidewall. The flexible portion allows the housing to bend to accommodate electrical likes which are not substantially parallel or coaxial with one another. However, the flexible portions can only bend so much to accommodate the conductive wires. While the electrical component cover shown in U.S. Pat. No. 11,087,901 is an improvement, there are still conductive electrical wires which are disposed at angles which make it difficult for the electrical component cover to be conveniently used.

Thus, there is a need for an adjustable electrical component cover which is made from flame resistant, generally rigid materials such as PVC/acrylics, but which can adapt to a wider range of the conductor orientations.

### SUMMARY OF THE INVENTION

The following summary of the present invention is not intended to describe each illustrated embodiment or every possible implementation of the invention, but rather to give illustrative examples of applications of principles of the invention.

In some configurations, the invention may comprise a housing formed from a first piece of material and a second piece of material. The housing may have a central portion which forms a receptacle for mounting on an insulator for an electrical power line.

In one or more applications, the central portion may be formed by at least partially overlapping the first piece of material and the second piece of material and attaching them together with a fastener which enables the first piece of material to rotate relative to the second piece of material.

In one or more applications, at least one of the first piece of material and the second piece of material may include at least one flexible portion disposed there along so as to allow that piece of material to flex and accommodate additional offset between two electrical power lines or power line segments.

In one or more applications, both the first piece of material and the second piece of material may include at least one flexible portion disposed there along. Such a structure allows for additional flexibility in the electrical component cover on both sides of the central portion.

In accordance with one aspect of the present disclosure, the central portion may be offset relative to the remaining portions so as to accept a side tie powerline arrangement.

In accordance with another aspect of the present disclosure, the central portion may be disposed generally inline with the other portions of the electrical component cover to accommodate a power line or powerline anchor which attaches to the top of an insulator.

The end portions may include engagement members designed to keep a power line within the cover of the housing and/or to engage and hold other line covers to increase the area of power lines which may be protected.

### BRIEF DESCRIPTION OF THE DRAWINGS

Various embodiments of the present disclosure are shown and described in reference to the numbered drawings wherein:

FIG. 1 illustrates a prior art electrical component cover as currently in use when covering electrical power lines which are in general alignment in accordance with the prior art.

FIG. 2 illustrates a side view of an electrical component cover of the prior art as taught in U.S. Pat. No. 11,087,901.

FIG. 3 shows a top view of an adjustable electrical component cover of the present disclosure.

FIG. 4 shows a side view of the adjustable electrical component cover of FIG. 3.

FIG. 5 shows the adjustable electrical component cover of FIG. 3 adjusted into an orientation which accommodates a lower line which has a change of direction.

FIG. 6 shows a side view of the adjustable electrical component cover of FIG. 5.

FIG. 7 shows a fragmented bottom view of the adjustable electrical component cover of FIG. 3 disposed on a power line which is side tied to an insulator wherein the power line extends generally tangentially to the insulator.

FIG. 8 shows a fragmented bottom view of the adjustable electrical component cover of FIG. 5 disposed on an insulator and power line wherein the power line changes direction by about 45 degrees as it passes by the insulator.

FIG. 9 shows another adjustable electric component cover.

FIG. 10 shows another adjustable electrical component cover in a first orientation.

FIG. 11 shows the adjustable electrical component cover in a second orientation.

FIG. 11A shows a variation of the adjustable electrical component cover of FIG. 11.

FIG. 12 shows a cross-sectional view of the adjustable electrical component cover of FIG. 10 taken through the central portion.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other, or all embodiments discussed herein, but is not required to be included unless expressly indicated.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such an aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be at least as vertical as horizontal, i.e. would extend 45 degrees or greater from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range, or the characteristics being described.

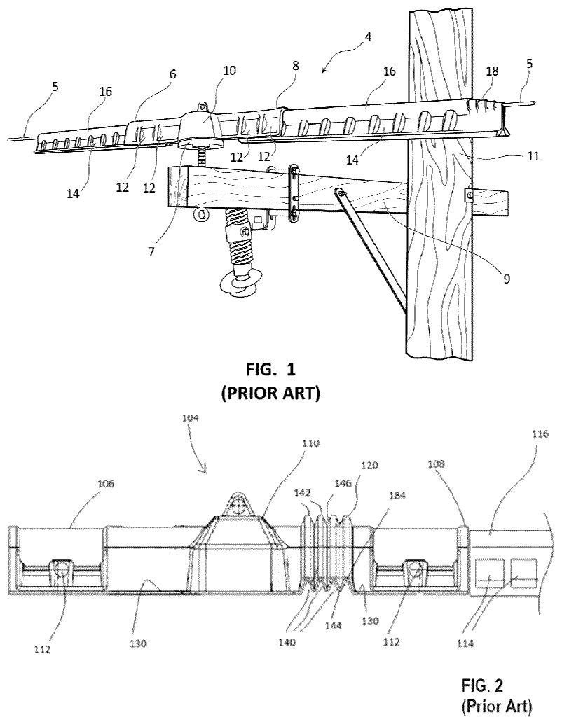

Turning now to FIG. 1, there is shown a perspective view of a prior art electrical component cover, generally indicated at 4. The electrical component cover includes a first end portion 6 and a second end portion 8 which extend from a central portion 10. The central portion 10 is configured to fit over an insulator 7 on a cross member 9 of a power pole 11. The first end portion 6 and the second end portion 8 each have a plurality of engagement members 12 which can both serve to hold the electrical component cover 4 on a power line 5, and which can engage engagement members 14 on a power line protector 16 to extend the length of the power line 5 which is covered to prevent conductive contact with the power line. The power line protector 16 may be provided with a stepped end 18. By cutting the stepped end 18, the person installing the powerline protector can size the end to be just slightly larger than the particular power line on which it is installed, thereby providing less movement in harsh weather conditions.

The electrical component cover 4 shown in FIG. 1 may be highly desirable when made from a material which is very durable and fire resistant. For example, KADDAS Enterprises of Salt Lake City has a PVC/acrylic blend which has a rating of 72 kV so it can be used on a wide variety of power lines. One drawback with the electrical component cover 4 is that it provides little flexibility. If the power line extends in substantially a straight line over the insulator, then the electrical component cover 4 may be easily attached. However, if the power line changes direction as it passes over the insulator the rigidity of the acrylic/PVC material makes it difficult to use as the ability of the electrical component cover 4 to bend to cover the power line is limited.

Turning now to FIG. 2 there is shown another prior art electrical component cover, generally indicated at 104, which is made from a housing which may include a first end portion 106, a second end portion 108, and a central portion 110 disposed therebetween. Each of the first end portion 106 and the second end portion 108 may include an engagement member 112 which may be formed by forming a depression into the top/outer side of the material forming the electrical component cover 104. The engagement member 112 may serve one or more purposes, including being used to help hold the electrical component cover 104 onto a power line. The engagement member 112 may also be used to engage a power line protector 116 similar to that shown in FIG. 1, by one or more engagement members 114 thereon to extend the shielded portion of a power line.

Disposed between the central portion 110 and the second end portion 108 is a flexible portion 120. The flexible portion 120 is formed by a bellows-like undulating sidewall portion where the sidewall portion extends outwardly and then extends inwardly and repeats the pattern one or more times. While the face 146 of the sidewall between each crest and each trough could be substantially flat, they may also transition between positive and negative curvatures.

In the embodiment shown in FIG. 2, the adjustable electrical component cover 104 may be thermoformed out of a single sheet of material. Forming the sheet of material into the electrical component cover 104 typically leaves a flange 130 which extends around the base of the housing forming the electrical component cover 104. While the flange 130 provides strength to the housing, it can interfere with the flexing of the undulating sidewall which forms part of the flexible portion 120. To this end, the sides of the sidewall forming the flexible portion 120 may be trimmed to remove the flange or to leave a small flange 184 at the top, and a portion of the undulating sidewall to leave generally arcuate or triangular recesses 140 at the base 128 of each of the crests.

While the structure shown in U.S. Pat. No. 11,087,901 provides a marked improvement in flexibility, there are situations wherein the configuration is less then ideal. For example, in some situations a power line is attached to an insulated in what is called a side tie. A metal tie is wrapped about the power line, around the insulator, and then back around the power line on the other side of the insulator so that the power line is held against the side of the insulator. Because of the angles at which the power line segments may leave the insulator, the electrical component cover 104 is less than ideal for adapting to the wide variety of geometries which may be encountered.

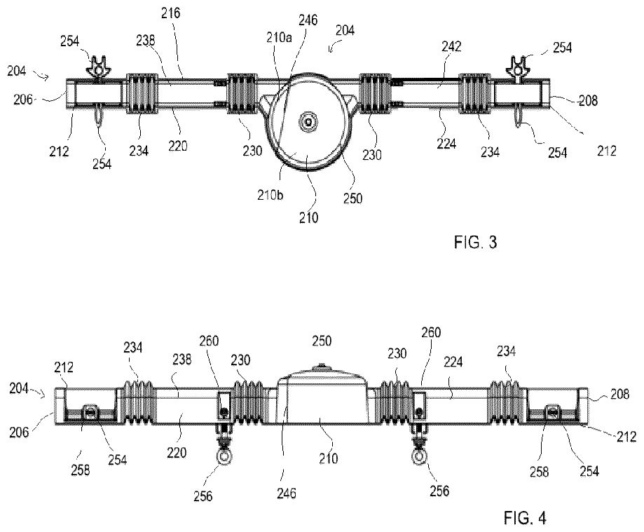

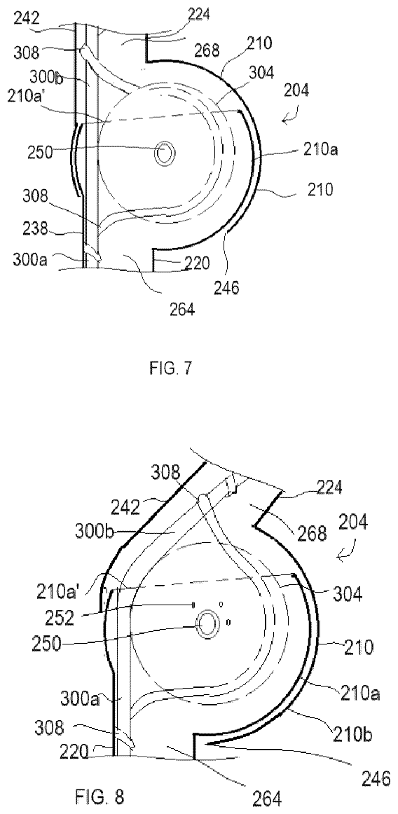

Turning now to FIG. 3, there is shown a top view of an adjustable electrical component cover, generally indicated at 204, which may include a first end 206, a second end 208 and a central portion 210 disposed therebetween. The central portion 210 may be sized and shaped to receive an insulator (FIGS. 7 and 8) with a power line attached thereto.

Each of the first end portion 206 and the second end portion 208 may include an engagement member 212 which may be formed by forming a depression into the top/outer side of the material forming the electrical component cover 204. The engagement member 212 may serve one or more purposes. The engagement member 212 may be used to help hold the electrical component cover 204 onto a power line. The engagement member 212 may also be used to engage a power line protector similar to that shown in FIG. 1 at 16 to extend the shielded portion of a power line.

The adjustable electrical component cover 204 may define a housing 216 which may be formed of a first cover member 220 which defines the first end portion 206 and a portion of the central portion 210, and a second cover member 224 which defines the second end portion 208 and which also forms part of the central portion. Each of the first cover member 220 and the second cover member 224 may be formed from a rigid or substantially rigid PVC/acrylic blend such as is discussed in U.S. Pat. No. 11,087,901, which is incorporated herein by reference.

The first cover member 220 may include an elongate sidewall 238 which is bent so as to form three sides defining a channel or a void 264 which extends along the first cover members from an opening at the first end 206 to an opening in a part of the first cover member, hereinafter the central portion part 210a, at an opposing end of the first cover member. The elongate wall 238 has an open bottom end for facilitating placement of a power line segment within the void 264 defined by the elongate sidewall 238.

Disposed along the elongate sidewall 238 may be one or more flexible portions, such as first flexible portion 230 and second flexible portion 234. As will be discussed in additional detail below, the first flexible portion 230 and/or second flexible portion 234 allow the elongate sidewall to flex and adapt to the orientation of the power line segment along which it is placed.

At central portion part 210a of the first cover member 220, may be disposed at an end of the sidewall 238 opposite first end portion 206, The sidewall 238 widens to form part of a void which has an open bottom to facilitate placement of an insulator into the central portion 210 of the adjustable electrical component cover. (See FIGS. 7-8).

The central portion part 210a of the first cover member 220 which forms part of the center portion 210 of the overall structure may be generally circular with an opening on one side where the remainder of the first cover member 220 extends, and a second opening on a side opposite to the first opening. Further detail regarding the central portion 210 is discussed with respect to FIGS. 7-12 below.

The second cover member 224 may also include an elongate sidewall 242 defining an elongate void 268 for receiving a power line segment. Disposed along the elongate sidewall 242 may be one or more flexible portions, such as first flexible portion 230 and second flexible portion 234 to allow the second cover member 224 to flex if necessary to accommodate the orientation of a power line segment.

At an end of the second cover member 224 opposite the second end 208, the sidewall 242 may expand to form or may be attached to a central portion part 210b which engages the central portion part 210a of the first cover member 220 to form the center portion 210. The central portion part 210b may be generally circular with an opening where sidewall 242 attaches or expands to connect with the elongate void 268 defined by the sidewall. The central portion part 210b may also have a second opening opposite the opening to the elongate void 268 which aligns with the opening into the void 264 in the first cover member 220.

The central portion part 210a of the first cover member 220 which forms part of the central portion 210 may be disposed substantially within the central portion part 210b of the second cover member 224 so that part of the first cover member central portion part extends out of the second opening 246 in the second cover member central portion part 210b. The opening 246 is large enough to allow the first cover member central portion part 210a move within the opening to thereby allow the first cover member 220 to pivot with respect to the second cover member 224. Thus, for example, the opening may be 40-90 degrees wide when measured from the center of the central portion 210. Depending on the size of the sidewall 238, this may allow a pivot of 15 to 60 degrees, i.e. an inner angle of 120 to 165 degrees.

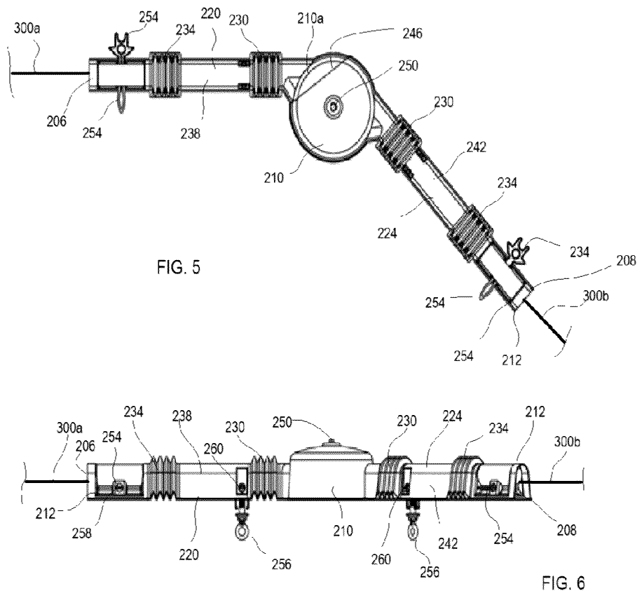

As will be discussed additionally with respect to the construction shown in FIG. 5, this range of motion may be between 30 and 60 degrees and most commonly between 40 and 50 degrees, with 45 degrees being a representative range of motion. The exact range of motion will depend on a variety of factors, such as the opening size, the sides of the sidewalls 238 and 242 and the voids extending therethrough.

The central portion part 210a of the first cover member 220 and the central portion part 210b of the second cover member 224 may be attached together by a rivet, a nut and bolt or other fastener 250 which allows the first cover member 220 and the second cover member 224 to rotate with respect to one another. Typically, this will be from a first orientation wherein the voids and a long axis passing through the cover members are in alignment or coplanar, to a second orientation wherein the voids a long axes of the cover members are offset with one another in a range may be between 20 and 90 degrees depending on the configuration.

Also shown in FIGS. 3 and 4 are a plurality of inserts 254 with can be inserted into a number of openings 258 in the first cover member 220 and the second cover member 224 to secure the adjustable electrical component cover 204 onto a power line (not shown). This is accomplished by placing the adjustable electrical component cover 204 on the power line segments to be covered and then advancing the inserts into a hole 258 on one side of the sidewall 238, 242, under the power line and out a hole on the opposing side so that the power line segments are held between the inserts and the sidewalls. FIG. 4 shows a side view of the adjustable electrical component cover 204, providing a better view of the flexible portions 230 and 234.

Turning now to FIGS. 5 and 6, there is shown a top view and a side view, respectively, of the adjustable electrical component cover 204 on a pair of power line segments 300a and 300b. The second cover member 224 has been rotated about the fastener 250 so the long axes of the first cover member 220 and the second cover member are now disposed at about 45 out of coplanar along a vertical plane. In other words, the power line segments have an inner angle between them of about 135 degrees. This facilitates the use of the adjustable electrical component cover 204 on a power line which has two segments which do not extend in a coplanar or coaxial configuration. If the inner angle between the power line segments 300a and 300b is between 135 and 180 degrees, the first cover member 220 and second cover member 224 can be rotated with respect to one another about the fastener so that the adjustable electrical component cover covers the power line segments and the insulator to which they are attached.

If the power line segments 300a and 300b are oriented with an inner angle of less than 135 degrees, the flexible portions 230 and 234 (if provided) can flex to provide additional range, Thus, for example, power line segments 300a and 300b could be disposed at roughly a right angle and the adjustable electrical component cover 204 will allow the power line segments on either side of the insulator to be shielded from wild animals and the like.

In FIGS. 4 and 6 there is also shown an anti-rotation clamp 256. As discussed in detail in U.S. Pat. No. 11,764,561, which is expressly incorporated herein, the anti-rotation clamp may include arms which extend through holes 260 in the sidewalls 238 or 242 and an engagement body which is disposed atop a threaded shaft. Rotating the threaded shaft in one direction drives the engagement body upwardly so as to pin a power line between the engagement body and the underside of the top of the sidewalls 238 or 242, thereby securing the power line within the component cover. The anti-rotation clamps 256 may be used in place of or in addition to the inserts 254 to ensure that the component cover 204 stays on the power line even in harsh environmental conditions.

Turning now to FIG. 7, there is shown a fragmented bottom view of the adjustable electrical component cover 204 disposed on power line segments 300a, 300b and an insulator 304. The first cover member 220 may have a central portion part 210a which is disposed substantially inside of the central portion part 210b of the second cover member 224 and may open at one end in communication with the void 264 defined by the sidewall 238 on one end and open on the opposing end 210a′ generally facing the void 268 defined by the sidewall 242 of the second cover member 224. The dashed line shows the top end of the first cover member as obscured by the insulator 304.

The power line 300 extends along the insulator 304 and it attached thereto by a side tie 308 which raps around the power line, then around the insulator and back around the power line to secure the power line to the insulator. In FIG. 7 the two segments 300a and 300b of the power line are substantially coplanar. Thus, the voids 264 and 268 in the first cover member 220 and the second cover member 224 are in alignment.

In FIG. 8, the two segments 300a and 300b of the power line are disposed at an inner angle of about 135 degrees from one another as the power line wraps part way about the insulator 304. To accommodate this orientation, the second cover member 224 has been rotated about the fastener 250 about 45 degrees from the first orientation shown in FIG. 7 to a second orientation in which the long axis of the first cover member 200 is disposed at an acute angle of about 130 degrees from the long axis of the second cover member 224. It will be appreciated that the fastener 250 may allow the first cover member 220 and the second cover member 224 to rotate with respect to one another, or may be tightened or otherwise fixed so as to hold the position at the desired angle once placed on the power lines. While FIG. 8 shows the angle as being an acute angle of 135 degrees, it will be appreciated that the second cover member 224 may be placed at angle between 135 and 180 depending on the needs of power line at any particular location. It will also be appreciated that detents 252 or other structures could be used to facilitate marking or placement of the two cover members at the desired angle. For example, if a lineman determines that the power line segments 300a and 300b are in an orientation where the inner angle is at 145 degrees from one other, the markings or detents 252 could be used to secure the first cover member 220 and the second cover member 224 at the correct angle with respect to one another prior to placement of the adjustable electrical cover 240 on the insulator 304 and power line segments 300a and 300b. Alternatively, the adjustable electrical component cover 204 could be adjusted while being placed on the power line segments 300a, 300b and insulator and then fastener 250 adjusted to lock the cover in the desired orientation.

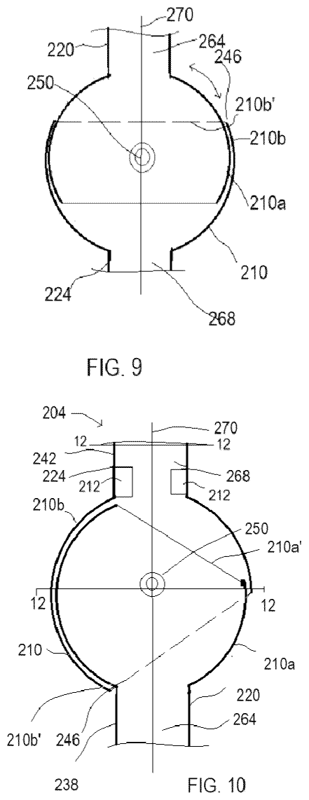

While FIGS. 3-8 show an application of the present disclosure for a side tie mounting of the power line 300, the principles of the present disclosure can also be used for a power line configured that extends over the top of the insulator. As shown in in FIG. 9, The voids 264 and 268 defined by the sidewalls 238 and 242 may be in alignment with the fastener 250 which forms the pivot point and the space between the opening 201b′ in the central portion part 210b of the second cover member 224 may be between 70 and 90 degrees short of the end of the sidewall 238, thereby allowing the first cover member to pivot between about 22.5 and 30 degrees in either direction from a long axis extending through the adjustable electrical component cover when in the initial orientation shown in FIG. 9.

FIG. 10 through 12 show bottom views and a cross-sectional view of another adjustable electrical component cover 204. In FIG. 10, the adjustable electrical component cover 204 is disposed in a first orientation wherein the voids 264 and 268 in the first cover member 220 and the second cover member 224, respectively, are in alignment along the long axis 270 of the adjustable electrical cover. The top end 210a′ of central portions part 210a of the first cover member 220 can be seen. The end 210b′ of the central portions part 210b of the second cover member 224 is shown by dashed line as it is on the opposite side of the central portions part 210a of the first cover member 220. In this first orientation, the power line or anchors therefrom can pass linearly through the adjustable electronic cover 204 over the top of the insulator (not show) without bending to either side. The central portion 210 receives the insulator and the remainder of the cover protects the power lines. Extensions such as 16 from FIG. 1 can be added to lengthen the cover and thereby provide additional protection. In FIGS. 10-12 the flexible portions 230, 234 and the remainders of the sidewalls 238, 242 (shown in FIGS. 3-6), etc., have been omitted for clarity. It will be appreciated that the flexible portions could also be included on the first cover member 220, the second cover member 224 or both.

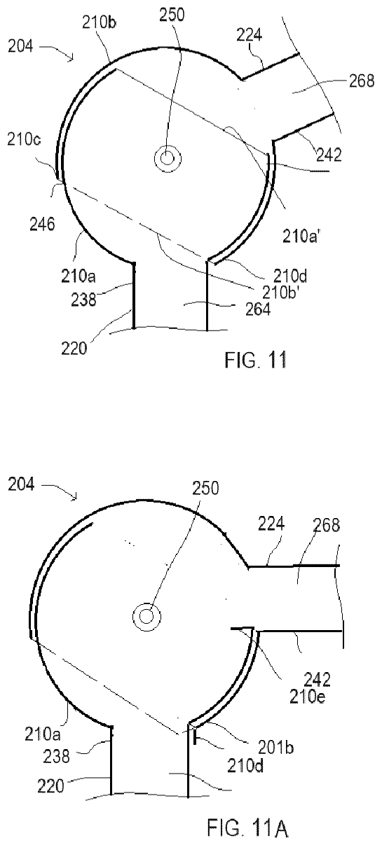

FIG. 11 shows the adjustable electrical component cover 204 of FIG. 10 wherein the second cover member 224 has been rotated about the fastener 250 in the central portion 210 so that sidewall 242 defining the void 268 in the second cover member is disposed at an acute angle of about 110 degrees to 120 degrees from the sidewall 238 defining the void 264 in the first cover member 220. While a rotation of 60-70 degrees is possible, a smaller rotation could be used if the two power line segments 300a, 300b (FIG. 5) were at an inner angle between 120 and 180 degrees. In other words, the end 210c of the longer part of the central portions part 210b of the second cover member has moved from a position adjacent to the sidewall 238 and the end 210d on the opposing, shorter side has moved adjacent to the sidewall 238 on the opposite side, thus providing a range of motion of about 60-70 degrees. If flexible members 230 or 234 are included one of the cover members could also bend to give a greater range of motion so as to accommodate, for example, a full 90-degree bend or even greater.

While the adjustable electrical component covers 204 shown in shown in FIGS. 3-8 and 10-12 can only be rotated on one side of the long axis, if a wire segment extends at an angle in the opposite direction, the adjustable electrical component cover 204 need merely be rotated in its entirety to accommodate the orientation of the power line segments 300a and 300b. Thus, for example, the power line segments had an inner angle of 135 degrees on the left side of the power line segments, the cover would simple be rotated 135 degrees and it would cover an orientation to the left with the first cover member 200 covering the second segment 300b and the second cover member 224 covering the first segment 300a.

It will be appreciated that it is presently preferred to have the central portion parts 210a and 210b of the first cover member 220 and the second cover member 224, respectively, overlap to prevent contact with the power line, such is not required, and it will be appreciated that the shorter sides of the central portion may be even shorter to provide a greater range of motion. Thus, a small gap could be left so as to enable the wire segments to be disposed at a right angle. Alternatively, wall portion 210d on the central portions part 210b of the second cover member and/or wall portion 210e on the central portions part 210a of the First cover member could be scored or be otherwise breakable or bendable to allow the second cover member to rotate a full 90 degrees or more from the original position so that the wire segments could extent at a right angle as shown in FIG. 11A. Once the adjustable electrical component cover 204 is disposed on the power line, the removed portions would not leave an opening which would leave the wire exposed as the cover would be held in a bent or adjusted position.

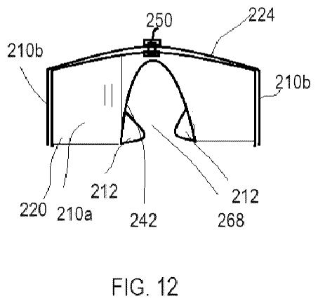

FIG. 12 shows a cross-sectional view taken along line 12-12 in FIG. 10. The central portion part 210a of the first cover member 220 is visible on the left side, but ends immediately after the cross-section on the right. The cross-sectional view shows a view down the void 268 formed by the sidewall 242 in the second cover member 224. At the back of the void the engagement member 212 which extends into the void 268 to engage the power line is also shown.

Thus, there is shown an adjustable electrical cover. It will be appreciated that numerous modifications may be made without departing from the scope and spirit of this disclosure. The appended claims are intended to cover such modifications.

What is claimed is:

1. An adjustable electrical component cover comprising a housing having a first end and a second end and a central portion configured to receive an insulator along a power line, wherein the housing comprises:
a first cover member forming the first end and a central portion part disposed opposite the first end, and
a second cover member forming the second end and a central portion part disposed opposite the second end.

2. The adjustable electrical component cover of claim 1, wherein the central portion part of the first cover member is rotationally attached to the central portion part of the second cover member to form the central portion of the adjustable electrical component cover.

3. The adjustable electrical component cover of claim 2, wherein the first cover member is rotationally attached to the second cover member by a rivet.

4. The adjustable electrical component cover of claim 2, wherein the first cover member is rotationally attached to the second cover member by a bolt.

5. The adjustable electrical component cover of claim 2 wherein the central portion part of the first cover member is disposed substantially within the central portion part of the second cover member, and wherein the central portion part of the first covert member rotates within the central portion part of the second cover member.

6. The adjustable electrical component cover of claim 2, wherein the first cover member has an elongate sidewall defining three sides of a void extending along the first cover member and wherein the central portion part of the first cover member extends from the elongate sidewall, the central portion part having a first opening at one end into the void within the elongate sidewall, and a second opening generally opposite the first opening.

7. The adjustable electrical component cover of claim 6, wherein the second opening in the central portion part of the first cover member is between 40 and 90 degrees wide when measured from a center of the central portion.

8. The adjustable electrical component cover of claim 2, wherein the second cover member has an elongate sidewall defining three sides of a void extending along the second cover member and wherein the central portion part of the second cover member extends from the elongate sidewall, the central portion part of the second cover member having a first opening at one end into the void within the elongate sidewall of the second cover member, and a second opening generally opposite the first opening.

9. The adjustable electrical component cover of claim 8, wherein the second opening in the central portion part of the second cover member is between 40 and 90 degrees wide when measured from a center of the central portion.

10. The adjustable electrical component cover of claim 1, wherein the first cover member has a long axis and the second cover member has a long axis, and wherein the adjustable electrical component is rotatable between a first orientation wherein the long axis of the first cover member and the long axis of the second cover are in alignment, and a second orientation wherein the long axis of first cover member is not in alignment of the second cover member.

11. The adjustable electrical component cover of claim 10, wherein the central portion of the adjustable electrical component has a point of rotation whereat the first cover member and the second cover member rotate with respect to one another and wherein the point of rotation in the central portion is not in alignment with the long axis of the first cover member.

12. The adjustable electrical component cover of claim 10, wherein the central portion of the adjustable electrical component has a point of rotation whereat the first cover member and the second cover member rotate with respect to one another and wherein the point of rotation in the central portion is in alignment with the long axis of the first cover member.

13. The adjustable electrical component cover of claim 1, wherein the central portion is generally circular.

14. An adjustable electrical component cover comprising:
a first cover member having a first open end and a second open end;
a second cover member having a first open end and a second open end;
wherein the second open end of the first cover member and the second open end of the second cover member overlap and a rotationally attached to one another so as to form a central portion in the adjustable electrical component cover, the central portion being sized and shaped to receive an insulator associated with a power line, and wherein the first cover member, the second cover member and the central portion form a continuous void extending from one end of the adjustable electrical cover to an opposing end of the electrical component cover with each end being open.

15. An electrical power system having a power line with a first segment and a second segment and an insulator, and wherein the adjustable electrical component cover of claim 14 is disposed such that the first cover member is disposed on the first power line segment, the second cover member is disposed on the second power line segment and the insulator is disposed in the central portion of the adjustable electrical component cover.

16. The electrical power system of claim 15, wherein the first segment and the second segment are side tied to the insulator, and wherein the first segment and the second segment are disposed at an angle, the inner angle being between 90 and 165 degrees.

17. The electrical power system of claim 15, wherein the first segment and the second segment engage the top of the insulator and wherein the and wherein the first segment and the second segment are disposed at an angle, the inner angle being between 90 and 165 degrees.

18. The adjustable electrical component cover of claim 14, wherein one opening in the central portion part of the first cover member is between 40 and 90 degrees wide when measured from a center of the central portion.

19. The adjustable electrical component cover of claim 18, wherein one opening in the central portion part of the second cover member is between 40 and 90 degrees when measured from the central of the central portion, and wherein the central portion part of the first cover member fills the one opening.

20. The adjustable electrical component cover of claim 14, wherein the central portion part of the first cover member and the central portion part of the second cover member form the central portion such that the central portion is substantially circular.
